(19) United States
(12) Patent Application Publication
(10) Pub. No.: US 2022/0380080 A1
(43) Pub. Date: Dec. 1, 2022

(54) Container For Liquids

(71) Applicant: Graphic Packaging International, LLC, Atlanta, GA (US)

(72) Inventor: Jeffrey T. Sloat, Broomfield, CO (US)

(21) Appl. No.: 17/825,118

(22) Filed: May 26, 2022

Related U.S. Application Data
(60) Provisional application No. 63/194,420, filed on May 28, 2021.

(51) Int. Cl. B65D 3/04; B65D 25/14; B65D 3/12; B65D 3/22

(52) U.S. Cl. CPC B65D 3/04; B65D 25/14; B65D 3/12; B65D 3/22

(57) ABSTRACT

A container can comprise a sidewall extending at least partially around an interior of the container, and the sidewall can have at least a first end margin and a second end margin. The sidewall can comprise at least a sidewall substrate layer, a sidewall base coat extending along the interior of the container, and a secondary layer extending in register along at least the first end margin of the sidewall. The container further can comprise a sidewall seam comprising the first end margin and the second end margin in an at least partially overlapping relationship. The secondary layer and the sidewall base coat extending along the first end margin can cooperate to form a heat seal along the sidewall seam.

### CROSS-REFERENCE TO RELATED APPLICATIONS

This application claims the benefit of U.S. Provisional Patent Application No. 63/194,420, filed on May 28, 2021.

### INCORPORATION BY REFERENCE

The disclosure of U.S. Provisional Patent Application No. 63/194,420, which was filed on May 28, 2021, is hereby incorporated by reference for all purposes as if presented herein in its entirety.

### BACKGROUND OF THE DISCLOSURE

The present disclosure generally relates to containers and constructs for forming containers and/or other suitable items. More specifically, the present disclosure relates to constructs for holding liquids (e.g., beverages) including a substrate and one or more coatings.

### SUMMARY OF THE DISCLOSURE

In general, one aspect of the disclosure is generally directed to a container. The container can comprise a sidewall extending at least partially around an interior of the container, and the sidewall can have at least a first end margin and a second end margin. The sidewall can comprise at least a sidewall substrate layer, a sidewall base coat extending along the interior of the container, and a secondary layer extending in register along at least the first end margin of the sidewall. The container further can comprise a sidewall seam comprising the first end margin and the second end margin in an at least partially overlapping relationship. The secondary layer and the sidewall base coat extending along the first end margin can cooperate to form a heat seal along the sidewall seam.

In another aspect, the present disclosure is generally directed to a blank for forming a container. The blank can comprise a sidewall having at least a first end margin and a second end margin. The sidewall can comprise at least a sidewall substrate layer, a sidewall base coat, and a secondary layer extending in register along at least the first end margin of the sidewall. The first end margin and the second end margin can be for being arranged in an at least partially overlapping relationship for forming a sidewall seam when the container is formed from the blank. The secondary layer and the sidewall base coat extending along the first end margin can be for cooperating to form a heat seal along the sidewall seam when the container is formed from the blank.

In another aspect, the present disclosure is generally directed to a method of forming a container. The method can comprise obtaining a sidewall blank having at least a first end margin and a second end margin. The sidewall blank can comprise at least a sidewall substrate layer, a sidewall base coat, and a secondary layer extending in register along at least the first end margin of the sidewall blank. The method further can comprise positioning the sidewall blank to extend at least partially around an interior of the container, forming a sidewall seam by at least partially overlapping the first end margin and the second end margin, and forming a heat seal along the sidewall seam. The heat seal can comprise at least the secondary layer and the sidewall base coat extending along the first end margin.

In another aspect, the present disclosure is generally directed to a method of forming one or more sidewall blanks for forming respective containers. The method can comprise obtaining a web of material comprising a substrate material, applying a base coat to at least a portion of the web of material to form a coated web, applying a secondary layer to the coated web, and at least partially forming a sidewall blank in the coated web. The sidewall blank can have at least a first end margin and a second end margin, and the secondary layer can be in register with the first end margin of the sidewall blank.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1A is a plan view of a sidewall blank for forming a sidewall of a container according to an exemplary embodiment of the disclosure.

FIG. 1B is a schematic cross-sectional view of the sidewall blank of FIG. 1A.

FIG. 2A is a plan view of a bottom blank for forming a bottom wall of the container according to the exemplary embodiment of the disclosure.

FIG. 2B is a schematic cross-sectional view of the bottom blank of FIG. 2A.

FIG. 3 is a perspective view of the container formed from the sidewall blank of FIGS. 1A and 1B and the bottom blank of FIGS. 2A and 2B according to the exemplary embodiment of the disclosure.

FIGS. 4A and 4B are schematic cross-sectional views of a seam of the container of FIG. 3.

FIG. 4C is a schematic cross-sectional view of a portion of a bottom of the container of FIG. 3.

FIGS. 5A and 5B are schematic plan views of a web of material showing an exemplary method of forming the sidewall blank of FIGS. 1A and 1B.

FIGS. 6A and 6B are schematic plan views of a web of material showing an alternative exemplary method of forming the sidewall blank of FIGS. 1A and 1B.

FIG. 7A is a plan view of an alternative bottom blank for forming a bottom wall of the container according to the exemplary embodiment of the disclosure.

FIG. 7B is a schematic cross-sectional view of the alternative bottom blank of FIG. 7A.

Corresponding parts are designated by corresponding reference numbers throughout the drawings.

### DETAILED DESCRIPTION OF THE EXEMPLARY EMBODIMENTS

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to a container for holding, heating, cooking, and/or shielding food items, beverage items, or various other articles. However, in other embodiments, the container can be used to form other non-food containing articles or may be used for refrigerating or other uses. In this specification, the terms “inner,” “interior,” “outer,” “exterior,” “lower,” “bottom,” “upper,” and “top” indicate orientations determined in relation to fully erected and upright cartons.

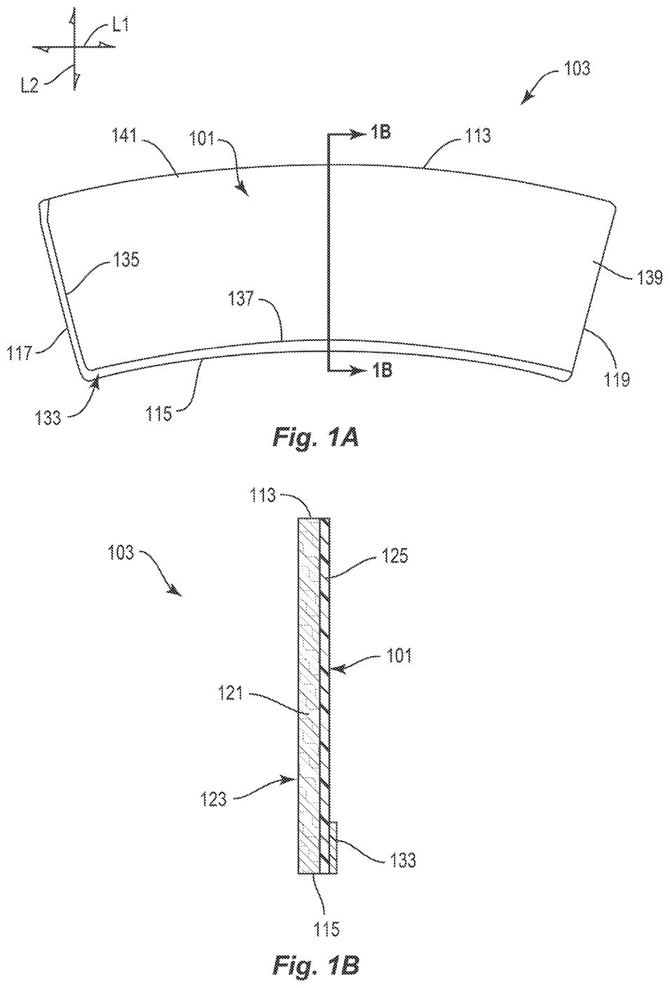

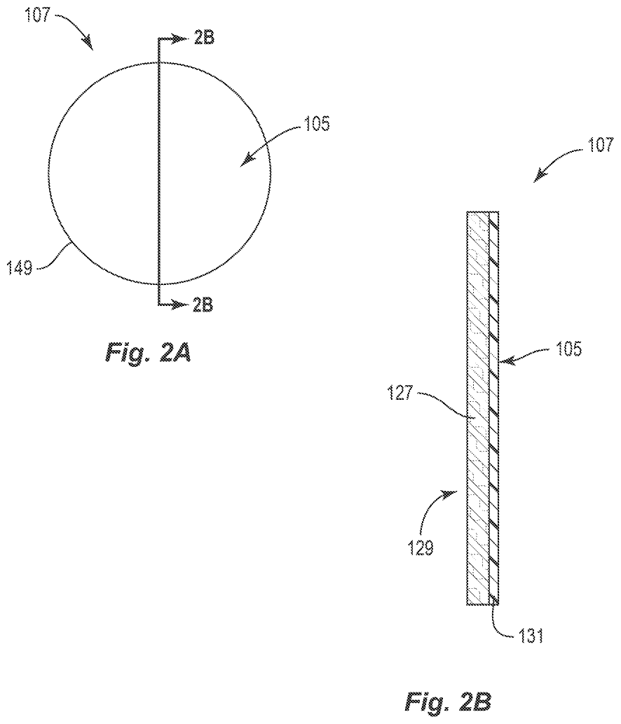

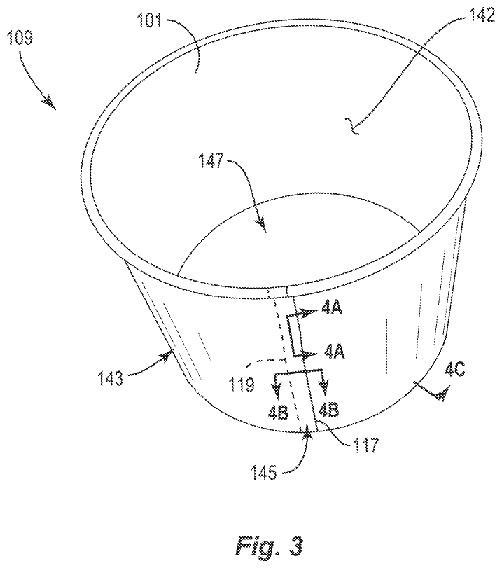

FIG. 1A is a plan view of the interior side 101 of a sidewall blank, generally indicated at 103, and FIG. 2A is a plan view of the interior side 105 of a bottom blank, generally indicated at 107, wherein the sidewall blank 103 and the bottom blank 107 are used in cooperation to form a container 109 (FIG. 3) according to an exemplary embodiment of the disclosure. In the illustrated embodiment, the container 109 is a cup for holding beverages and/or other liquids. Alternatively, the container 108 could be any suitable container such as a cup, a tray, a bowl, etc. for holding food and/or beverage items or other suitable liquid and/or solid materials. The container 109 could be alternatively shaped and/or could be alternatively formed without departing from the scope of this disclosure.

In the illustrated embodiment, the sidewall blank 103 has a longitudinal axis L1 and a lateral axis L2. In the illustrated embodiment, the sidewall blank 103 comprises a top edge 113, a bottom edge 115, a first end edge 117, and a second end edge 119 extending from the respective ends of the top and bottom edges 113, 115. In one embodiment, the top edge 113 can comprise a convex curve (e.g., having a radius of curvature extending away from the bottom edge 115), and the bottom edge 115 can comprise a concave curve (e.g., having a radius of curvature extending toward the top edge 113) so that the sidewall blank 103 forms a generally cylindrical sidewall that is at least partially tapered (e.g., the diameter at the top of the sidewall is greater than the diameter at the bottom of the sidewall) as shown by way of example in FIG. 3. Further, as shown in FIG. 1, the end edges 117, 119 can be oblique, extending at an acute angle with respect to the lateral direction L2. As shown in FIG. 2A, the bottom blank 107 can have a generally circular perimeter. The sidewall blank 103 and/or the bottom blank 107 could be otherwise shaped, arranged, positioned, and/or configured without departing from the disclosure. For example, one or more of the edges 113, 115, 117, 119 could be orthogonal or generally orthogonal and/or straight or generally straight and can, for example, form cylindrical sidewall that is not tapered (e.g., that has a generally constant diameter) without departing from the disclosure.

As shown in the schematic cross-sectional view of FIG. 1B, the sidewall blank 103 can include a sidewall substrate or support layer 121 extending along an exterior surface 123 of the sidewall blank 103 and a primary layer or sidewall base coat 125 extending along the interior side 101 of the sidewall blank 103. Similarly, as shown in the schematic cross-sectional view of FIG. 2B, the bottom blank 107 can include a bottom substrate or support layer 127 extending along an exterior (or bottom) surface 129 of the bottom blank 107 and a bottom base layer or coat 131 extending along the interior side 105 of the bottom blank 107. In one embodiment, each of the substrates 121, 127 can be formed from one or more layers of a paper-based material (e.g., paperboard, cardboard, etc.) and/or could be formed of any other suitable material. In exemplary embodiments, the paperboard or other substrate material can be without a clay coating or the like. In an exemplary embodiment, the base coats 125, 131 can be liquid barrier layers that can help reduce fluids from being absorbed and/or passing through the substrate at least for as long as the container 109 is intended to hold a liquid.

In some embodiments, the base coats 127, 129 can be polyethylene (PE) or a similar material. PE and similar materials can be inexpensive, can be easy to apply to the substrates 127, 129 (e.g., by extrusion or flood coating), and can provide sufficient heat sealing properties for forming the seams of the container 109 as described in more detail below. However, in embodiments, PE can be made from non-renewable sources and/or can lead to difficulties in recycling a container formed by a paper-based material coated with the PE (e.g., it may be difficult to sufficiently separate the PE and the paper-based material to recover paper fibers and/or PE material for recycling). In some embodiments, materials that can be made at least partially from renewable sources and/or that can be more easily recycled (e.g., that can be more easily separated from the paper-based substrate) and/or that is compostable (e.g., in a residential setting and/or in a commercial composting process) may be used for the coatings. Such materials can include water-based materials and/or other suitable materials. However, these materials can be more expensive so that coating the substrates 121, 127 with sufficient material to form a base coat 125, 131 that can provide sufficient liquid barrier for the container 109 and that would allow for heat sealing of the seams of the container 109 can undesirably raise the cost of the packaging. Reducing the thickness of the base coats 125, 131 can reduce the amount of the more expensive material used, but can result in reduced heat sealing capabilities of the material (e.g., the thickness of the base coat may not have enough thermal mass to form a heat seal).

In the illustrated embodiment, the sidewall blank 103 can include a heat seal enhancement layer or secondary layer 133 extending along an end margin 135 and a bottom margin 137 of the sidewall blank 103. In exemplary embodiments, the secondary layer 133 can be the same material as the base coat 125 or can be another suitable material. For example, the base coat 125 and the secondary layer 133 could comprise any suitable material (e.g., any suitable material for coating the substrate and/or for forming a heat seal), such as ethylene-vinyl acetate (EVA), bio-based materials including polylactic acid (PLA) and polyhydroxyalkanoates (PHA), other polyesters, PE, and the like in any suitable combination. The materials can be applied in a water-based emulsion, which can be annealed to cause the polymer(s) in the emulsion to coalesce and form the respective layer. Alternatively, one or more of the layers can be applied by extrusion or other suitable methods.

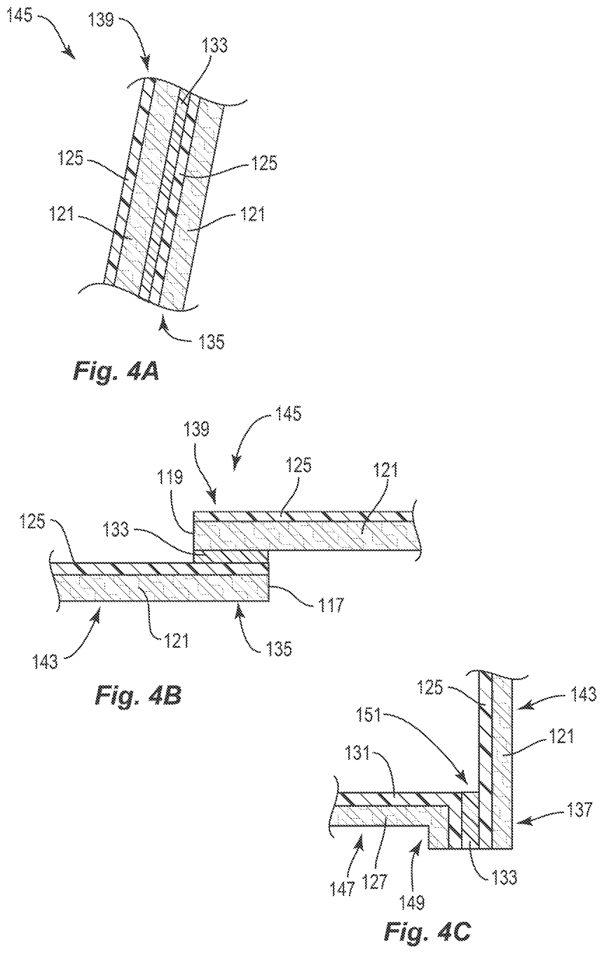

As shown in FIG. 1A, the end margin 135 extends along the end edge 117 of the sidewall blank 103 and the bottom margin 137 extends along the bottom edge 115 of the sidewall blank 103. In the illustrated embodiment, a second end margin 139 extending along the end edge 119 of the sidewall blank 103, opposite to the first end margin 135, and a top margin 141 can be at least partially free of the secondary layer 133 (e.g., except where the end margin 139 intersects with the bottom margin 137 and where the top margin 141 intersects with the first end margin 135). Alternatively, in an exemplary embodiment, the secondary layer 133 can extend in the second end margin 139 and/or the top margin 141. In embodiments, the width of the secondary layer 133 (e.g., the distance the secondary layer extends from the edges of the sidewall blank 103) is equal (e.g., about equal, generally equal, substantially equal, etc.) to the amount of overlap at the sidewall seam and at the bottom seam (e.g., as shown in FIGS. 4A-4C described in more detail below). For example, a container can have between about 5 mm to about 10 mm of overlap or other suitable amounts of overlap. In embodiments, configuring the secondary layer 133 to fit within or to match the widths of the seams can help avoid wasted material to help control costs of the container 109 and/or reduce the environmental impact of manufacturing the container. In some embodiments, the secondary layer 133 can cover less than 10% or substantially less than 10% of the surface of the sidewall blank 103, for example. In an exemplary embodiment, the secondary layer 133 can cover approximately 5% or less of the surface of the sidewall blank 103, for example.

In the illustrated embodiment, the secondary layer 133 can have a thickness so that it provides sufficient material in addition to the thickness of the base coat 125 along the end margin 135 and the bottom margin 137 to form a sealed seam and for attaching the bottom blank 107 to the sidewall blank 103, respectively, as described in more detail below. In one example, the secondary layer 133 can double the thickness of the heat seal material on the substrate 121. In embodiments, the thickness of the layers (e.g., the secondary layer 133 and/or the base coats 125, 131) can result from the amount (e.g., weight) of the water-based emulsion applied to a web when forming the blanks. For example, the secondary layer 133 can be applied in a water-based emulsion with about 50% solids at about 0.1 pounds to about 3 pounds of emulsion per 1000 square feet of substrate 121. Such an application can have a thickness of about 2 microns to about 50 microns prior to annealing and can result in the secondary layer 133 having a thickness of about 2 microns to about 25 microns after drying, for example. Any of the base coats 125, 131 and/or the secondary layer 133 could be omitted or could be otherwise shaped, arranged, positioned, and/or configured without departing from the disclosure. For example, the secondary layer 133 could extend on the second side margin 139 in addition to or instead of on the first side margin 1.

In the illustrated embodiment, the sidewall blank 103 and the bottom blank 107 can be formed into the container 109 having an interior 142 as shown in FIG. 3. For example, the sidewall blank 103 can be bent and curved (e.g., around a mandrel, not shown) to form a sidewall 143 of the carton 109. As shown in FIG. 3, the end margins 135, 139 adjacent the respective end edges 117, 119 overlap one another to form a seam 145 of the sidewall 143. As shown in the schematic cross-sectional views of FIGS. 4A and 4B, the seam 145 includes the portions of the base coat 125 and the secondary layer 133 that extend along the first end margin 135 positioned between the portions of the substrate 121 that extend along the first end margin 135 and the second end margin 139. The portion of the base coat 125 that extends along the second end margin 139 faces toward the interior 142 of the container 109. In one embodiment, the base coat 125 and the secondary layer 133 can cooperate to form a heat seal along the seam 145, wherein heat and/or pressure can be applied along the seam so that the base coat 125 and the secondary layer 133 fuse the end margins 135, 139 together and form a seal (e.g., a liquid-proof or liquid resistant seal). The sidewall 143 and/or the seam 145 could be otherwise formed without departing from the disclosure.

As shown in FIGS. 3 and 4C, the bottom blank 107 can be secured to the interior surface 102 of the sidewall 143 to form a bottom wall 147 of the container 109. In the illustrated embodiment, the bottom wall 147 and the sidewall 143 can extend around and form the interior 142 of the container 109. In one embodiment, a marginal portion 149 of the bottom wall 147 can be folded with respect to the central portion of the bottom wall and attached in face-to-face contact with the bottom margin 137 of the sidewall 143 to form a bottom seam 151 (FIG. 4C). The marginal portion 149 of the bottom wall 147 and the bottom margin 137 of the sidewall 143 can be heat sealed together by applying heat and/or pressure so that the secondary layer 133 of the bottom margin 137 cooperates with the base coat 125 of the bottom margin 137 and/or with the base coat 131 of the marginal portion 149 to fuse the marginal portion 149 and the bottom margin 137 together and form a seal (e.g., a liquid-proof or liquid resistant seal) along the bottom seam 151. The bottom wall 147 could be otherwise formed and/or could be otherwise sealed to the sidewall 143 without departing from the disclosure.

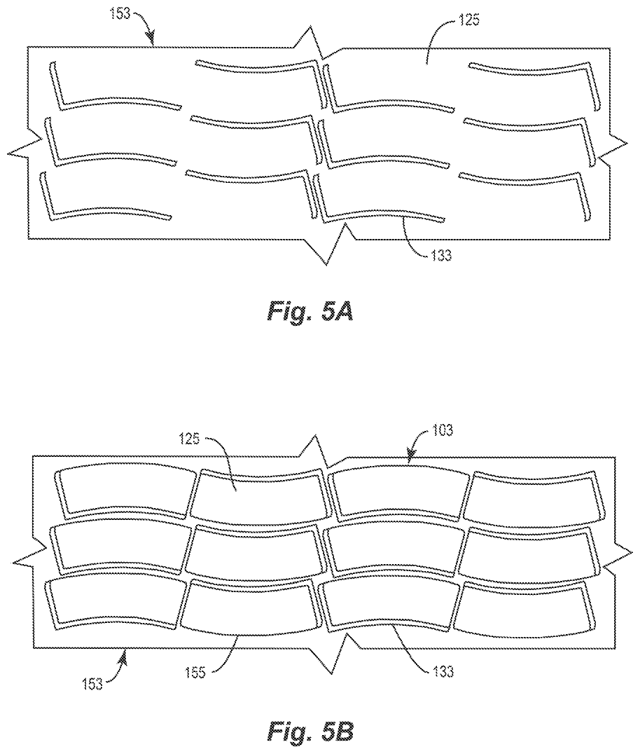

In an exemplary embodiment, as shown in FIGS. 5A and 5B, the sidewall blanks 103 can be formed in an array on a web of material 153. In one embodiment, the web of material 153 can be the substrate material. The base coat 125 can be applied to the web of material 153 (e.g., by flood coating, extrusion, printing, etc.) at a predetermined weight and/or thickness (e.g., a thickness sufficient to form a desired liquid resistant layer). The coated web can be annealed, dried, and/or cooled and the secondary layers 133 of the respective sidewall blank 103 can be applied to the coated web in register along what will become the first end margins 135 and the bottom margins 137 of the sidewall blanks 103 in the web (FIG. 5A). For example, the secondary layers 133 can be printed on the coated web, such as by a printing plate or a print roller (e.g., gravure printing). After annealing, drying, and/or cooling the web with the secondary layers 133, the web can be cut along the edges of the respective sidewall blanks 103 to form cut lines 155 extending along a perimeter of the sidewall blanks 103 (FIG. 5B). The sidewall blanks 103 can be removed from the web by separating the blanks from the web along the respective cut lines 155. The sidewall blanks 103 could be otherwise formed without departing from the disclosure.

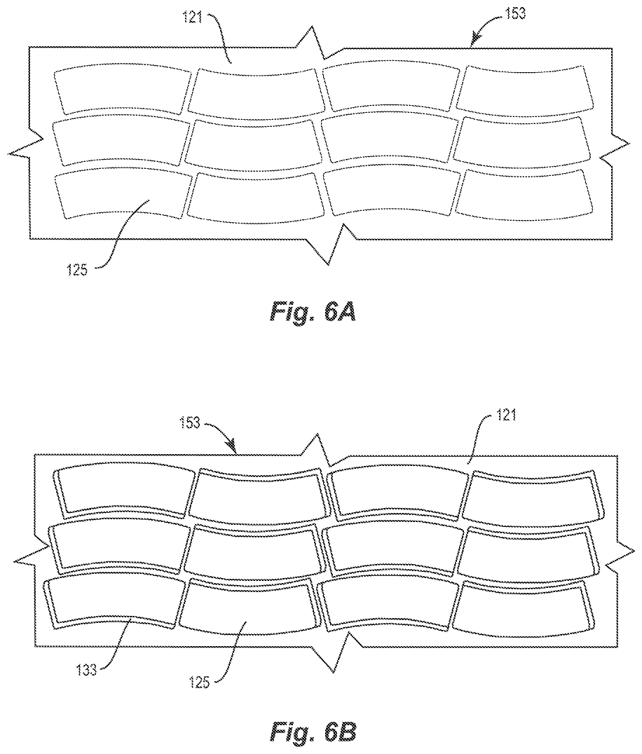

In another embodiment, as shown in FIGS. 6A and 6B, the base coat 125 for each sidewall blank 103 can be printed on the web of material 153 in register with the respective sidewall blanks (FIG. 6A). The coated web can be annealed, dried, and/or cooled and the secondary layers 133 can be printed in register at a second printing station. Subsequently, the web can be dried and/or cooled and the sidewall blanks 103 can be cut from the web. The sidewall blanks 103 could be otherwise formed without departing from the disclosure.

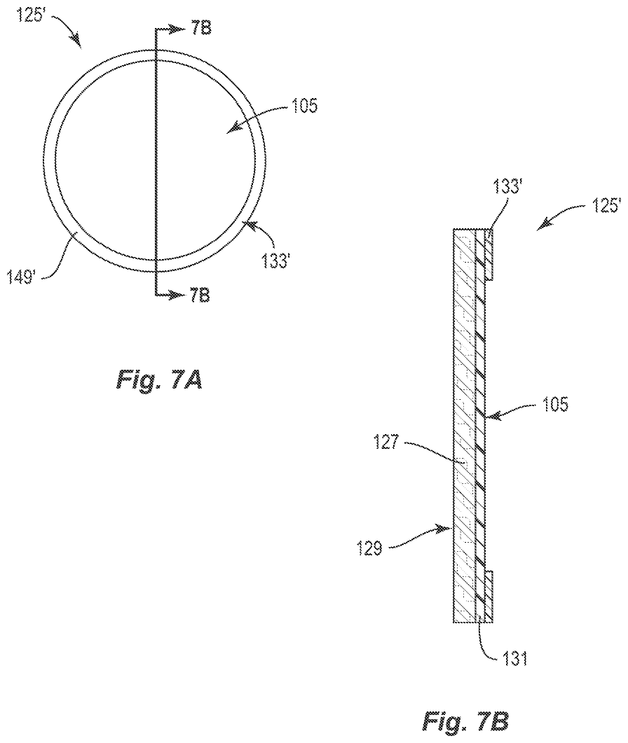

In an alternative embodiment shown in FIGS. 7A and 7B, a secondary layer 133′ can be formed along the marginal portion 149′ of the bottom blank 125′. In embodiments, the secondary layer 133′ can replace or supplement the secondary layer 133 extending in the bottom margin 137 of the sidewall 143 when the bottom seam 151 is formed. The bottom blank 125′ could be otherwise shaped, arranged, positioned, and/or configured without departing from the disclosure.

Any of the dimensions and/or other parameters noted above or otherwise included in this disclosure are approximate and could be larger or smaller than noted or could be inside or outside the listed ranges without departing form the scope of the disclosure. All of the dimensional information presented herein is intended to be illustrative of certain aspects of the disclosure and is not intended to limit the scope of the disclosure, as various other embodiments of the disclosure could include dimensions that are greater than or less than the dimensions included herein.

The blanks according to the present invention can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blanks. The blanks may also be coated with, for example, a moisture barrier layer, on either or both sides of the blanks.

In accordance with the exemplary embodiments, the blanks and/or other constructs may be constructed of paperboard of a caliper such that it is heavier and more rigid than ordinary paper. The blanks can also be constructed of other materials, such as cardboard, hard paper, or any other material having properties suitable for enabling the carton package to function at least generally as described above.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A container, comprising:
a sidewall extending at least partially around an interior of the container, the sidewall having at least a first end margin and a second end margin;
the sidewall comprising at least a sidewall substrate layer, a sidewall base coat extending along the interior of the container, and a secondary layer extending in register along at least the first end margin of the sidewall; and
a sidewall seam comprising the first end margin and the second end margin in an at least partially overlapping relationship, wherein the secondary layer and the sidewall base coat extending along the first end margin cooperate to form a heat seal along the sidewall seam.

2. The container of claim 1, wherein the sidewall base coat extends along the interior of the container on the second end margin and on a portion of the sidewall extending between the first end margin and the second end margin.

3. The container of claim 2, wherein the sidewall base coat extends along the interior of the container on a portion of the sidewall extending adjacent the first end margin.

4. The container of claim 1, wherein a portion of the sidewall extending adjacent the first end margin is free from the secondary layer.

5. The container of claim 1, wherein the sidewall base coat extends on the sidewall substrate layer, and the secondary layer extends on a portion of the sidewall substrate layer extending along the first end margin.

6. The container of claim 1, wherein at least one of the sidewall base coat and the secondary layer comprises at least one of a renewable material, a compostable material, and a bio-derived material.

7. The container of claim 1, wherein at least one of the sidewall base coat and the secondary layer comprises at least one of EVA, PLA, and PHA.

8. The container of claim 1, wherein a portion of an exterior surface of the sidewall extending along the secondary end margin engages the secondary layer extending along the first end margin along the sidewall seal.

9. The container of claim 1, wherein a portion of the second end margin that extends along the interior of the container is free from the secondary layer.

10. The container of claim 1, further comprising a bottom wall extending along the interior of the container, wherein the sidewall further comprises a bottom margin, wherein a portion of the bottom wall and the bottom margin are in an overlapping relationship along a bottom seam of the container, and wherein the secondary layer and the sidewall base coat extend along the bottom margin cooperate to at least partially form a bottom heat seal along the bottom seam of the container.

11. The container of claim 10, wherein the bottom wall comprises a bottom wall substrate layer and a bottom wall base coat extending along the interior of the container, the bottom wall base coat cooperating with the sidewall base coat and the secondary layer to at least partially form the bottom heat seal along the bottom seam of the container.

12. A blank for forming a container, the blank comprising:
a sidewall having at least a first end margin and a second end margin;
the sidewall comprising at least a sidewall substrate layer, a sidewall base coat, and a secondary layer extending in register along at least the first end margin of the sidewall;
wherein the first end margin and the second end margin are for being arranged in an at least partially overlapping relationship for forming a sidewall seam when the container is formed from the blank, and wherein the secondary layer and the sidewall base coat extending along the first end margin are for cooperating to form a heat seal along the sidewall seam when the container is formed from the blank.

13. The blank of claim 12, wherein the sidewall base coat extends along an interior side of the blank on the second end margin and on a portion of the sidewall extending between the first end margin and the second end margin.

14. The blank of claim 13, wherein the sidewall base coat extends along the interior side of the blank on a portion of the sidewall extending adjacent the first end margin.

15. The blank of claim 12, wherein a portion of the sidewall extending adjacent the first end margin is free from the secondary layer.

16. The blank of claim 12, wherein the sidewall base coat extends on the sidewall substrate layer, and the secondary layer extends on a portion of the sidewall substrate layer extending along the first end margin.

17. The blank of claim 12, wherein at least one of the sidewall base coat and the secondary layer comprises at least one of a renewable material, a compostable material, and a bio-derived material.

18. The blank of claim 12, wherein at least one of the sidewall base coat and the secondary layer comprises at least one of EVA, PLA, and PHA.

19. The blank of claim 12, wherein a portion of the second end margin that extends along an interior side of the container is free from the secondary layer.

20. The blank of claim 12, wherein the sidewall further comprises a bottom margin is for being in an overlapping relationship with at least a portion of a bottom wall along a bottom seam of the container formed from the blank, and wherein the secondary layer and the sidewall base coat extend along the bottom margin.

21. A method of forming a container, the method comprising:
obtaining a sidewall blank having at least a first end margin and a second end margin, the sidewall blank comprising at least a sidewall substrate layer, a sidewall base coat, and a secondary layer extending in register along at least the first end margin of the sidewall blank;
positioning the sidewall blank to extend at least partially around an interior of the container;
forming a sidewall seam by at least partially overlapping the first end margin and the second end margin; and
forming a heat seal along the sidewall seam, the heat seal comprising at least the secondary layer and the sidewall base coat extending along the first end margin.

22. The method of claim 21, wherein the sidewall base coat extends along the interior of the container on the second end margin and on a portion of the sidewall extending between the first end margin and the second end margin.

23. The method of claim 22, wherein the sidewall base coat extends along the interior of the container on a portion of the sidewall extending adjacent the first end margin.

24. The method of claim 21, wherein the forming the sidewall seam comprises engaging a portion of an exterior surface of the sidewall extending along the secondary end margin with the secondary layer extending along the first end margin.

25. The method of claim 21, wherein the sidewall further comprises a bottom margin and the secondary layer and the sidewall base coat extending along the bottom margin, the method further comprising positioning a bottom wall along the interior of the container, forming a bottom seam of the container by at least partially overlapping a portion of the bottom wall and the bottom margin, and forming a bottom heat seal along the bottom seam of the container, the bottom heat seal comprising at least the secondary layer and the sidewall base coat.

26. The method of claim 25, wherein the bottom wall comprises a bottom wall substrate layer and a bottom wall base coat extending along the interior of the container, the bottom wall base coat cooperating with the sidewall base coat and the secondary layer to at least partially form the bottom heat seal along the bottom seam of the container.

27. A method of forming one or more sidewall blanks for forming respective containers, the method comprising:
obtaining a web of material comprising a substrate material;
applying a base coat to at least a portion of the web of material to form a coated web;
applying a secondary layer to the coated web; and
at least partially forming a sidewall blank in the coated web, the sidewall blank having at least a first end margin and a second end margin;
wherein the secondary layer is in register with the first end margin of the sidewall blank.

28. The method of claim 27, wherein the applying the base coat comprises flood coating the base coat on the web of material.

29. The method of claim 27, wherein the applying the base coat comprises applying the base coat in register with the sidewall blank.

30. The method of claim 27, wherein the applying the secondary layer comprises printing the secondary layer in register with the first end margin of the sidewall blank.

31. The method of claim 27, wherein the applying the secondary layer to the coated web comprises applying a plurality of secondary layers spaced on the coated web, wherein the at least partially forming a sidewall blank in the coated web comprises at least partially forming a plurality of sidewall blanks in the coated web, and wherein each secondary layer of the plurality of secondary layers is in register with the first end margin of a respective sidewall blank of the plurality of sidewall blanks.
